(19) United States
(12) Patent Application Publication
(10) Pub. No.: US 2020/0313243 A1
(43) Pub. Date: Oct. 1, 2020

(54) METHOD OF MANUFACTURING NICKEL-ZINC BATTERY

(71) Applicant: TOYOTA JIDOSHA KABUSHIKI KAISHA, Toyota-shi (JP)

(72) Inventor: Hiroshi NISHIYAMA, Okazaki-shi (JP)

(21) Appl. No.: 16/783,327

(22) Filed: Feb. 6, 2020

(30) Foreign Application Priority Data
Mar. 26, 2019 (JP) 2019-057603

(51) Int. Cl. H01M 10/28; H01M 10/44; H01M 4/38; H01M 4/66; H01M 4/72; H01M 10/30

(52) U.S. Cl. CPC H01M 10/288; H01M 10/446; H01M 4/38; H01M 2004/021; H01M 4/667; H01M 4/72; H01M 10/30; H01M 4/661

(57) ABSTRACT

Provided is a method capable of manufacturing a highly durable nickel-zinc battery in which a short circuit due to a dendrite is prevented. The method of manufacturing a nickel-zinc battery disclosed herein includes the steps of: preparing a laminated body of a positive electrode, a porous negative electrode current collector, and a separator; accommodating the laminated body in a battery case with an electrolyte solution including zinc oxide dissolved therein to fabricate a battery assembly; and subjecting the battery assembly to charging and discharging. The charging and discharging causes a negative electrode active material to be precipitated, thereby supplying the negative electrode active material in the negative electrode current collector.

### BACKGROUND OF THE INVENTION

### 1. Field of the Invention

The present disclosure relates to a method of manufacturing a nickel-zinc battery. The present application claims priority based on Japanese Patent Application No. 2019-057603, filed on Mar. 26, 2019, the entire contents of which are incorporated herein by reference.

### 2. Description of the Related Art

A nickel-zinc battery typically includes a positive electrode including a positive electrode active material (i.e., nickel hydroxide or nickel oxyhydroxide), a negative electrode including a negative electrode active material (i.e., zinc or zinc oxide), a separator for insulating these electrodes, and an alkaline electrolyte solution. As a specific structure of these electrodes, a structure is known in which an active material is filled in the holes of a porous current collector (e.g., see Japanese Patent Application Publication No. 2018-133171).

A nickel-zinc battery has advantages of having high high-rate discharging performance, and being usable at lower temperatures. In addition, a nickel-zinc battery has an advantage of high safety due to use of a nonflammable alkaline electrolyte solution. Further, a nickel-zinc battery does not use lead, cadmium, or the like, and hence has an advantage of small environmental load.

### SUMMARY OF THE INVENTION

A nickel-zinc battery uses a dissolution-precipitation reaction of zinc for the charging and discharging reaction. For this reason, when the reaction ununiformly occurs, a dendrite of zinc is formed. When charging and discharging are repeated, the dendrite breaks through a separator, thereby entailing a short circuit with a positive electrode. This has long been known. A nickel-zinc battery undesirably has a low durability due to the dendrite-induced short circuit. The solution thereto has been desired for many years.

Under such circumstances, it is an object of the present disclosure to provide a method capable of manufacturing a highly durable nickel-zinc battery in which a short circuit due to a dendrite is prevented.

A method of manufacturing a nickel-zinc battery disclosed herein includes the steps of:

preparing a laminated body of a positive electrode, a porous negative electrode current collector, and a separator;

accommodating the laminated body in a battery case with an electrolyte solution including zinc oxide dissolved therein to fabricate a battery assembly; and

subjecting the battery assembly to charging and discharging.

The charging and discharging causes a negative electrode active material to be precipitated, thereby supplying the negative electrode material in the negative electrode current collector.

In accordance with such a configuration, it is possible to manufacture a highly durable nickel-zinc battery in which a short circuit due to a dendrite is prevented.

In accordance with one desirable aspect of the method of manufacturing a nickel-zinc battery disclosed herein, the porous negative electrode current collector has a three-dimensional network structure.

With such a configuration, the porous negative electrode current collector has a large surface area where the negative electrode active material can be precipitated, and the growth direction of a dendrite is dispersed, making a short circuit due to the dendrite particularly less likely to occur.

In accordance with one desirable aspect of the method of manufacturing a nickel-zinc battery disclosed herein, the porous negative electrode current collector is a copper-plated nonwoven fabric.

With such a configuration, the negative electrode is highly flexible, and hence the degree of freedom of design of the negative electrode is enhanced.

### BRIEF DESCRIPTION OF THE DRAWINGS

FIG. 1 is a flowchart showing the steps of a method of manufacturing a nickel-zinc battery in accordance with one embodiment of the present disclosure;

FIG. 2 is a partial perspective view schematically showing a configuration example of a nickel-zinc battery manufactured by the manufacturing method in accordance with one embodiment of the present disclosure;

FIG. 3 is a cross sectional view schematically showing one example of a form of a conventional negative electrode;

FIG. 4 is a cross sectional view schematically showing one example of a form of a negative electrode in the manufacturing method in accordance with one embodiment of the present disclosure;

FIG. 5 is a cross sectional view schematically showing another example of the form of the negative electrode in the manufacturing method in accordance with one embodiment of the present disclosure; and

FIG. 6 is a graph showing the evaluation results (capacity retention rates) of the cycle characteristics of nickel-zinc batteries of Example and Comparative Examples.

### DESCRIPTION OF THE PREFERRED EMBODIMENTS

Below, referring to the accompanying drawings, embodiments in accordance with the present disclosure will be described. It should be noted that matters necessary for executing the present disclosure, except for matters specifically referred to in the present specification (e.g., a general configuration and a manufacturing process of a nickel-zinc battery not featuring the present disclosure) can be grasped as design matters of those skilled in the art based on the related art in the present field. The present disclosure can be executed based on the contents disclosed in the present specification, and the common general technical knowledge in the present field. Further, in the accompanying drawings, the members/portions exerting the same action are given the same reference number and sign, and are described. Further, the dimensional relationships (such as length, width, or thickness) in each drawing do not reflect the actual dimensional relationships.

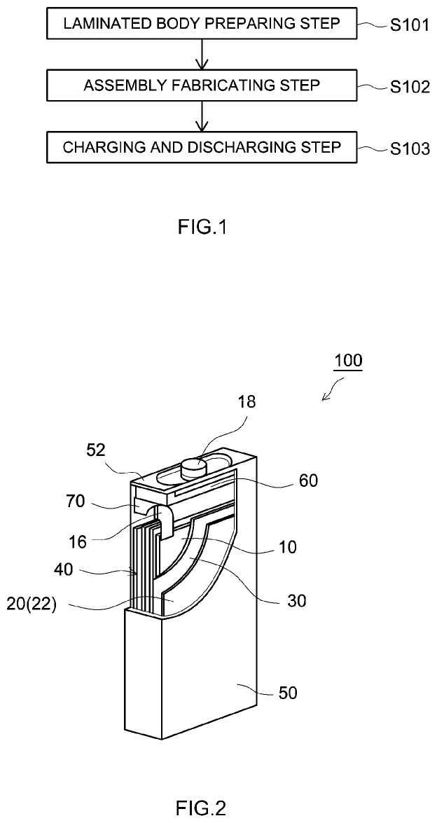

FIG. 1 shows the steps of a method of manufacturing a nickel-zinc battery in accordance with the present embodiment.

A method of manufacturing a nickel-zinc battery in accordance with the present embodiment includes a step (laminated body preparing step) S101 of preparing a laminated body of a positive electrode, a porous negative electrode current collector, and a separator, a step (assembly fabricating step) S102 of accommodating the laminated body in a battery case with an electrolyte solution including zinc oxide dissolved therein to fabricate a battery assembly, and a step (charging and discharging step) S103 of subjecting the battery assembly to charging and discharging. Herein, the charging and discharging causes a negative electrode active material to be precipitated, thereby supplying the negative electrode active material in the negative electrode current collector.

FIG. 2 schematically shows a configuration of a nickel-zinc battery 100 as one example of the configuration of the nickel-zinc battery manufactured by the manufacturing method in accordance with the present embodiment.

First, the laminated body preparing step S101 will be described. In the step S101, a laminated body 40 of a positive electrode 10, a porous negative electrode current collector 22, and a separator 30 are prepared.

For the positive electrode 10, a conventionally known positive electrode for use in a nickel-zinc battery may be used.

Specifically, the positive electrode 10 typically includes a positive electrode current collector, and a positive electrode active material supported by the positive electrode current collector.

Examples of the form of the positive electrode current collector may include punched metal, expanded metal, mesh, foam, and Celmet.

As the material forming the positive electrode current collector, a metal having an alkali resistance is desirable, and nickel is more desirable.

As the positive electrode active material, at least one of nickel hydroxide and nickel oxyhydroxide is used. For the positive electrode, the positive electrode active material causes the following electrochemical reaction.

Ni(OH)₂+OH⁻→NiOOH+H₂O+e⁻ [Charging]

NiOOH+H₂O+e⁻→Ni(OH)₂+OH⁻ [Discharging]

From the viewpoint of improvement of the battery characteristics, zinc, cobalt, cadmium, or the like may be incorporated to form a solid solution in the positive electrode active material. From the viewpoint of improvement of the battery characteristics, the surface of the positive electrode active material may be coated with metal cobalt, cobalt oxide, or the like.

Further, the positive electrode 10 may include a conductive material, a binder, and the like. Namely, in the positive electrode 10, a positive electrode mixture material including a positive electrode active material and other components may be supported by a positive electrode current collector.

Examples of the conductive material may include cobalt oxyhydroxide, and precursors thereof.

Examples of the binder may include polyvinylidene fluoride (PVDF), polyvinyl alcohol (PVA), hydroxypropyl methyl cellulose (HPMC), carboxymethyl cellulose (CMC), and sodium polyacrylate (SPA).

The separator 30 is a member interposed between the positive electrode and the negative electrode, and for insulating the positive electrode and the negative electrode, and transmitting hydroxide ions. For the separator 30, a conventionally known separator for use in a nickel-zinc battery may be used.

For the separator 30, for example, a porous film made of a resin, or a nonwoven fabric made of a resin can be used. Examples of the resin may include polyolefins (such as polyethylene (PE) or polypropylene (PP)), fluorine type polymer, cellulose type polymer, polyimide, and nylon.

The separator 30 may be of a monolayered structure, or may be of a lamination structure of two or more layers (e.g., a three-layered structure in which PP layers are stacked on both surfaces of a PE layer).

Further, as the separator 30, a material in which an oxide such as alumina or silica, or a nitride such as aluminum nitride or silicon nitride is attached to a porous base material can be used.

With a method of manufacturing a general nickel-zinc battery, a positive electrode, a negative electrode, and a separator are stacked. However, in the present embodiment, in the laminated body preparing step S101, a porous negative electrode current collector 22 is stacked in place of the completed negative electrode. Therefore, in the laminated body preparing step S101, basically no negative electrode active materials are added into the holes of the porous negative electrode current collector 22. (Namely, it is allowable that the negative electrode active material is added beforehand in a very small amount (e.g., 10 vol % or less based on the volume of the hole) in the holes of the porous negative electrode current collector 22 within such a range as not to impair the effects of the present disclosure; however, it is a general form and desirable that the negative electrode active material is not added into the holes of the porous negative electrode current collector 22.) Note that, at the negative electrode of the nickel-zinc battery, the following electrochemical reaction occurs, and hence the negative electrode active material is at least one of zinc and zinc oxide.

ZnO+H₂O+2e⁻→Zn+2OH⁻ [Charging]

Zn+2PH⁻→ZnO+H₂O+2e⁻ [Discharging]

The form of the porous negative electrode current collector 22 has no particular restriction so long as the porous negative electrode current collector 22 has a plurality of through holes. Mention may be made of punched metal, expanded metal, mesh, foam, and Celmet. Alternatively, mention may be made of a sheet material with the top of the embossed convex part opened, and the like.

As the material forming the porous negative electrode current collector 22, a metal with a high electric conductivity is desirable, copper and copper alloy (e.g., brass) are more desirable, and copper is most desirable.

Further, for the negative electrode current collector 22, it is sufficient that at least the surface has an electric conductivity. For this reason, it may also be configured such that the surface is made of copper or copper alloy, and the inside is made of another material such as nickel. The material for the inside is not limited to a metal. Accordingly, a copper-plated nonwoven fabric, or the like can also be used as the negative electrode current collector 22.

As the negative electrode current collector 22, the one having a three-dimensional network structure is desirable, because the one having a three-dimensional network structure has a large surface area where the negative electrode active material can be precipitated, and the direction of growth of a dendrite is dispersed, and hence a short circuit due to the dendrite is particularly less likely to be caused. Specifically, a foam, Celmet, and a copper-plated nonwoven fabric are desirable. Out of these, a copper-plated nonwoven fabric is more desirable because of the high flexibility, and the high degree of freedom of design of the negative electrode.

The surface of the porous negative electrode current collector 22 may be plated with a metal such as zinc or tin, and is desirably plated with tin. Such plating can suppress the generation of hydrogen from the negative electrode current collector 22.

Lamination of the positive electrode 10, the porous negative electrode current collector 22, and the separator 30 can be performed in the same manner as the lamination of the positive electrode, the negative electrode, and the separator during manufacturing of a general nickel-zinc battery. It should be noted that the separator 30 is interposed between the positive electrode 10 and the porous negative electrode current collector 22.

The numbers of the positive electrodes 10 and the negative electrode current collectors 22 for use in the laminated body 40 have no particular restriction. The laminated body 40 may be fabricated using one positive electrode 10 and one negative electrode current collector 22. Alternatively, the laminated body 40 may be fabricated using a plurality of positive electrodes 10 and a plurality of negative electrode current collectors 22. Still alternatively, the laminated body 40 may be fabricated by sandwiching one positive electrode 10 between two negative electrode current collectors 22.

Then, the assembly fabricating step S102 will be described. In the step S102, the laminated body 40 is accommodated with an electrolyte solution (not shown) including zinc oxide dissolved therein in a battery case 50, thereby fabricating a battery assembly.

The step can be performed in the same manner as a known method, except for using the laminated body 40 in place of an electrode body of lamination of a positive electrode, a negative electrode, and a separator, and using, as an electrolyte solution, the one including zinc oxide dissolved therein.

Specifically, for example, first, the battery case 50 including a lid body 52 is prepared. On the case inside side of the lid body 52, a gasket 60 is provided, and further, a spacer 70 is provided.

A positive electrode terminal 18 and a negative electrode terminal (not shown) are respectively attached to the battery case 50.

A positive electrode current collector member 16 is attached to the positive electrode 10 of the laminated body 40. A negative electrode current collector member (not shown) is attached to the negative electrode current collector 22 of the laminated body 40.

The laminated body 40 is inserted into the battery case 50, and the positive electrode 10 and the positive electrode terminal 18 are electrically connected with each other via the positive electrode current collector member 16. Similarly, the negative electrode current collector 22 and the negative electrode terminal are electrically connected with each other via the negative electrode current collector member.

Subsequently, an electrolyte solution is injected into the battery case 50.

For the electrolyte solution for use in the assembly fabricating step S102, as the electrolyte, generally, alkali metal hydroxide is used. Examples of the alkali metal hydroxide may include potassium hydroxide, sodium hydroxide, and lithium hydroxide. Out of these, potassium hydroxide is desirable.

As the solvent of the electrolyte solution, generally, water is used.

The concentration of the electrolyte has no particular restriction, and is desirably 5 mol/L or more and 11 mol/L or less.

Further, zinc oxide is dissolved in the electrolyte solution. The higher the concentration of zinc oxide in the electrolyte solution is, the larger the battery capacity is. For this reason, the concentration of zinc oxide in the electrolyte solution is desirably a concentration of 60% or more of the saturation concentration of zinc oxide, more desirably a concentration of 80% or more of the saturation concentration of zinc oxide, and most desirably the saturation concentration of zinc oxide.

Then, the charging and discharging step S103 will be described. In the charging and discharging step S103, the battery assembly is subjected to charging and discharging. The electrolyte solution includes zinc oxide dissolved therein. For this reason, by subjecting the battery assembly to charging and discharging, the dissolved zinc oxide is precipitated, so that a negative electrode active material is supplied into the holes of the negative electrode current collector 22. As a result, the negative electrode 20 is fabricated, resulting in completion of the nickel-zinc battery 100. Herein, the negative electrode active material is at least one of zinc and zinc oxide.

In the nickel-zinc battery 100 manufactured in this manner, a short circuit due to dendrite is suppressed. Accordingly, the nickel-zinc battery 100 has high durability. The reason for this is as follows.

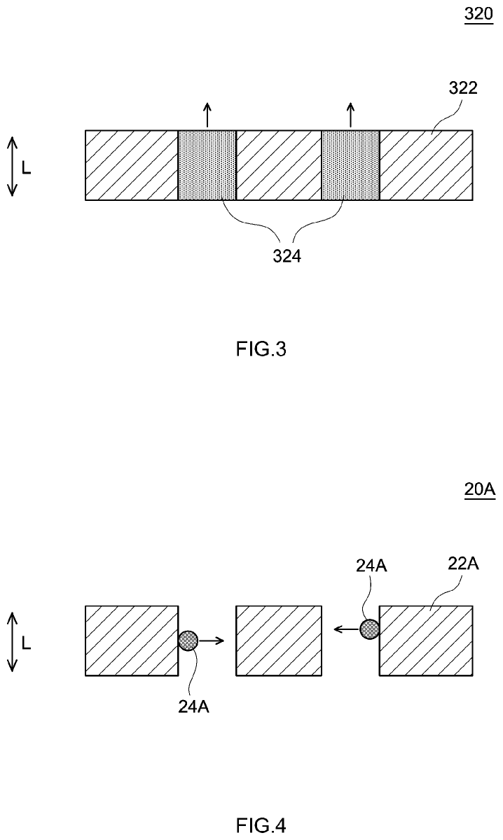

In the related art, the negative electrode has a configuration in which a negative electrode mixture material layer is provided at a foil-shaped negative electrode current collector, a configuration in which the porous negative electrode current collector is filled with a negative electrode mixture material, or other configurations. With such a configuration, a dendrite tends to grow toward the opposite positive electrode. FIG. 3 shows one example of a negative electrode in a conventional form. In a negative electrode 320 shown in FIG. 3, as a negative electrode current collector 322, a punched metal is used. The holes of the negative electrode current collector 322 are filled with a negative electrode mixture material 324 including a negative electrode active material. L in FIG. 3 indicates the direction of lamination of the positive electrode, the negative electrode 320, and the separator. When a dendrite is generated in this form, the direction in which growth is possible is the direction along the lamination direction L as the arrow of FIG. 3. The lamination direction L is the direction opposed to the positive electrode. For this reason, when charging and discharging are repeated, a dendrite tends to grow very much toward the opposite positive electrode.

In contrast, in the present embodiment, the negative electrode active material is basically not supplied beforehand into the holes of the negative electrode current collector 22. In the charging and discharging step S103, the negative electrode active material is supplied by being precipitated into the holes of the negative electrode current collector 22.

FIG. 4 shows one example of the negative electrode 20 in the present embodiment. In the negative electrode 20A shown in FIG. 4, as the negative electrode current collector 22A, a punched metal is used. L in FIG. 4 shows the lamination direction of the positive electrode, the negative electrode 20A, and the separator. In the charging and discharging step S103, a negative electrode active material particle 24A is precipitated in the holes of the negative electrode current collector 22A. When a dendrite is generated, the growth direction is mainly the direction perpendicular to the surface of the holes of the negative electrode current collector 22A (the direction of an arrow of FIG. 4). The lamination direction L is the direction opposed to the positive electrode. Accordingly, for the punched metal, the surface of the hole does not face the direction opposed to the positive electrode. For this reason, when charging and discharging are repeated, the dendrite growth toward the opposite positive electrode is less likely to occur.

Further, FIG. 5 shows another example of the negative electrode 20 in the present embodiment. In the negative electrode 20B shown in FIG. 5, as the negative electrode current collector 22B, a foam having a three-dimensional network structure is used. L in FIG. 5 shows the lamination direction of the positive electrode, the negative electrode 20B, and the separator. In the charging and discharging step S103, a negative electrode active material particle 24B is precipitated in the holes of the negative electrode current collector 22B. When a dendrite is generated, the growth direction is mainly the direction perpendicular to the surface of the holes of the negative electrode current collector 22B (the direction of an arrow of FIG. 5). In the foam, most of the surface of the hole does not face the direction opposed to the positive electrode (i.e., the direction along the lamination direction L). For this reason, when charging and discharging are repeated, the dendrite growth toward the opposite positive electrode is less likely to occur. Further, in FIG. 5, the negative electrode current collector 22B has a three-dimensional network structure. For this reason, the surface area where the negative electrode active material can be precipitated is large, and the direction of growth of the dendrite is dispersed.

As described up to this point, in the present embodiment, the negative electrode active material is basically not supplied beforehand into the holes of the negative electrode current collector 22. The electrolyte solution includes zinc oxide, which is a negative electrode active material. In the porous negative electrode current collector 22, at least a part of the surface of the hole (particularly, 50% or more, and further 90% or more of the surface of the hole) does not face the direction opposed to the positive electrode 10. For this reason, when charging and discharging are repeated, the dendrite growth toward the direction of the positive electrode 10 is less likely to occur. This suppresses the short circuit caused by the following: a dendrite breaks through the separator and extends to the positive electrode. As a result, the reduction of the battery characteristics upon repeating charging and discharging is suppressed, resulting in an increase in durability of the nickel-zinc battery 100.

The nickel-zinc battery 100 in accordance with the present embodiment is usable for various uses. As desirable uses, mention may be made of household or industrial backup power supply, and driving power supplies to be mounted on vehicles such as electric vehicle (EV), hybrid vehicle (HV), and plug-in hybrid vehicle (PHV).

Below, Examples in accordance with the present disclosure will be described. However, it is not intended that the present disclosure is limited to those shown in such Examples.

### Example 1

### Fabrication of Battery Assembly

A positive electrode in which a positive electrode mixture material including nickel hydroxide, polyvinylidene fluoride (PVDF), metal cobalt, and carboxymethyl cellulose (CMC) filled in foamed nickel was prepared. It should be noted that in the positive electrode mixture material, the mass ratio of nickel hydroxide, PVDF, metal cobalt, and CMC was set at 90:3:4:3. Further, the weight per unit area of the positive electrode mixture material was set at 60 mg/cm². The thickness of the positive electrode was 300 μm.

As the separator, a polypropylene nonwoven fabric with a thickness of about 150 μm was prepared.

As the porous negative electrode current collector, foamed copper having the surface plated with tin having a thickness of about 3 μm was prepared.

The positive electrode, the separator, and the porous negative electrode current collector were stacked so that the separator was interposed between the positive electrode and the negative electrode current collector. The laminated body was bound by being sandwiched by acrylic plates.

Terminals were attached to the laminated body, which was accommodated in a battery case. An electrolyte solution was injected into the battery case, thereby obtaining a battery assembly. The electrolyte solution obtained by saturating a 30 mass % potassium hydroxide aqueous solution with zinc oxide was used.

### Charging Operation and Cycle Characteristics Evaluation

The fabricated battery assembly was constant-current charged at a current value of 1/10 C for 10 hours, followed by constant-current discharging at a current value of ⅕ C up to 1.2 V, as a first charging and discharging cycle.

Then, as a second charging and discharging cycle, constant-current charging was performed at a current value of ⅕ C for 5 hours, followed by constant-current discharging at a current value of ⅕ C up to 1.2 V.

Subsequently, as a third charging and discharging cycle, constant-current charging was performed at a current value of ½ C for 2 hours, followed by constant-current discharging at a current value of ½ C up to 1.2 V.

From this point forward, the third charging and discharging cycle was repeated, thereby performing a maximum of 100 cycles of charging and discharging.

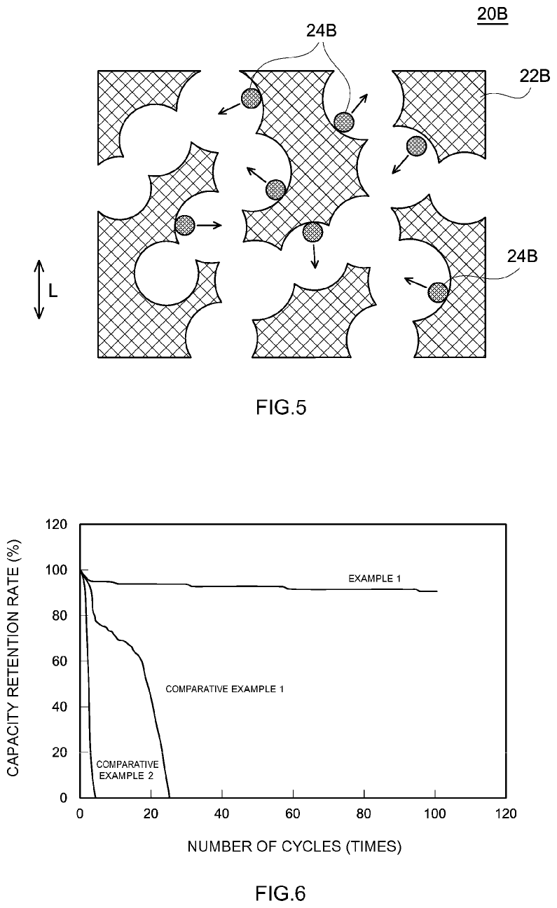

Using the values of the discharge capacity upon the first charging and discharging cycle, and the discharge capacity at a prescribed number of cycles, the capacity retention rate (%) was calculated. The results are shown in FIG. 6.

### Comparative Example 1

The same positive electrode and separator as those of Example 1 were prepared. Copper foil with a thickness of 10 μm was prepared as the negative electrode current collector. Thereon, according to an ordinary method, a negative electrode mixture material layer including zinc oxide, zinc, carboxymethyl cellulose (CMC), and styrene butadiene rubber (SBR) was formed at a weight per unit area of 22 mg/cm². In the negative electrode mixture material layer, the mass ratio of zinc oxide, zinc, CMC, and SBR was set at 90:10:1:4. In this manner, a negative electrode was fabricated.

The positive electrode, the separator, and the negative electrode were stacked so that the separator was interposed between the positive electrode and the negative electrode, resulting in an electrode body. The resulting electrode body was bound by being sandwiched by acrylic plates.

Terminals were attached to the electrode body, which was accommodated into a battery case. An electrolyte solution was injected into the battery case, thereby obtaining a battery assembly. The electrolyte solution obtained by saturating a 30 mass % potassium hydroxide aqueous solution with zinc oxide was used.

The battery assembly was subjected to the same charging and discharging cycle as that of Example 1, thereby determining the capacity retention rate. The results are shown in FIG. 6.

### Comparative Example 2

The same positive electrode and separator as those of Example 1 were prepared.

A negative electrode current collector including copper foil with a thickness of 10 μm plated with tin with a thickness of 3 μm was prepared.

The positive electrode, the separator, and the porous negative electrode current collector were stacked so that the separator was interposed between the positive electrode and the negative electrode current collector. The laminated body was bound by being sandwiched by acrylic plates.

Terminals were attached to the laminated body, which was accommodated in a battery case. An electrolyte solution was injected into the battery case, thereby obtaining a battery assembly. The electrolyte solution obtained by saturating a 30 mass % potassium hydroxide aqueous solution with zinc oxide was used.

The battery assembly was subjected to the same charging and discharging cycle as that of Example 1, thereby determining the capacity retention rate. The results are shown in FIG. 6.

Comparative Example 1 is a manufacturing example of a nickel-zinc battery having a negative electrode with a conventional general configuration. When charging and discharging were repeated, the capacity rapidly decreased due to the generated dendrite.

Comparative Example 2 is different from Comparative Example 1 in using copper foil not having a negative electrode active material layer. It should be noted that the copper foil is nonporous. In Comparative Example 2, precipitation of zinc oxide on the copper foil upon charging and discharging resulted in formation of the negative electrode active material layer. However, the negative electrode active material layer was not sufficiently formed.

On the other hand, in Example 1, precipitation of zinc oxide in the foamed copper upon charging and discharging resulted in formation of the negative electrode active material layer. However, as distinct from the Comparative Examples, even when charging and discharging cycles were imposed thereon 100 times, a short circuit due to a dendrite was prevented, resulting in a higher capacity retention rate. This can be considered due to the following fact: the negative electrode current collector is porous, and hence the growth direction of the dendrite was dispersed, thereby suppressing the growth of the dendrite.

From the above, it is clear that, in accordance with the method of manufacturing a nickel-zinc battery disclosed herein, a highly durable nickel-zinc battery in which a short circuit due to a dendrite is prevented can be manufactured.

Up to this point, specific examples of the present disclosure have been described in detail. However, these are merely illustrative, and are not intended to restrict the appended claims. The art described in the appended claims includes various changes and modifications of the specific examples shown up to this point.

What is claimed is:

1. A method of manufacturing a nickel-zinc battery, comprising the steps of:
preparing a laminated body of a positive electrode, a porous negative electrode current collector, and a separator;
accommodating the laminated body in a battery case with an electrolyte solution including zinc oxide dissolved therein to fabricate a battery assembly; and
subjecting the battery assembly to charging and discharging,
wherein the charging and discharging causes a negative electrode active material to be precipitated, thereby supplying the negative electrode active material in the negative electrode current collector.

2. The method of manufacturing according to claim 1,
wherein the porous negative electrode current collector has a three-dimensional network structure.

3. The method of manufacturing according to claim 2,
wherein the porous negative electrode current collector is a copper-plated nonwoven fabric.
